(19) United States
(12) Patent Application Publication
(10) Pub. No.: US 2004/0034730 A1
(43) Pub. Date: Feb. 19, 2004

(54) System and device for hot docking and undocking

(76) Inventor: Te-Hua Yu, Jung-Ii City (TW)

Correspondence Address: LIU & LIU LLP, Suite 1100, 811 West 7th Street, Los Angeles, CA, 90017, US

(21) Appl. No.: 10/222,174

(22) Filed: Aug. 16, 2002

(51) Int. Cl. G06F 13/00

(52) U.S. Cl. 710/304

(57) ABSTRACT

A system and device for performing hot docking and undocking operations in a docking station without the use of a PCI bridge. A combination of CMOS logic circuits functions to generate new PCI signals BUS_IDLE, PCI_EN_REQ, and PCI_SW_EN# which operate during docking and docking functions according to a timing specification. PCI _EN_REQ is a new trigger signal to initiate hot docking or undocking operations, BUS_IDLE indicates the state of the PCI bus (on a portable computer) when no devices are accessing the bus, PCI_SW_EN# functions to open the PCI bus to connect the portable computers PCI bus to the dock PCI bus. A process for using the circuits to accomplish docking and undocking functions is also disclosed.

### BACKGROUND OF THE INVENTION

1. Field of the Invention

This invention relates generally to a system for hot insertion and removal of portable devices from a docking station or bay. More specifically this invention provides a system and device for hot swapping of peripheral devices in a PCI based system, and particularly to replacing the PCI Bridge in traditional docking station systems, which is capable of detecting the PCI bus state of the portable device, sending signals from the portable device to request docking or undocking procedures, and appropriately isolating the PCI bus on the portable device from the PCI bus on the dock during hot docking and undocking procedures.

2. Description of Related Art

In the field of portable computing, the use of docking stations or docking bays as a means to extend the functionality and ease of use in portable computers is well known. Early docking systems required users to completely power down a portable computer before engaging docking or undocking operations with the docking station. More recently however, “hot docking” or “hot swappable” systems have overcome many of the disadvantages associated with these early docking systems. Today, conventional so called “hot docking” systems, which allow for a portable device which is powered on (or “hot”) to be connected or disconnected from a docking station, typically involve the use of a PCI bridge to accomplish connection and control functions between the PCI bus of the portable computer and PCI devices on the dock.

Because of the speed at which PCI busses operate, typically no more than 4 PCI devices may be operated by a single bus. PCI bridge mechanisms were developed to enable larger numbers of PCI devices to be controlled by electrically isolating two PCI busses while allowing bus transfers to be forwarded from one bus to another. This is accomplished via primary and secondary PCI busses on the PCI bridge itself in conjunction with precise timing specifications and control software. Given the unique challenge presented in connecting a running system to PCI devices on a docking station, the PCI bridge architecture was adopted as a means to accomplish hardware handshaking without compromising electrical components in either the computer or dock. Signal pins or proximity detection mechanisms have additionally been used to trigger or initiate the docking or undocking sequences in the PCI bridge system such that additional protection during insertion or removal from the dock is achieved. Once physically connected, all address, data and controlling signals of the portable device pass through the PCI Bridge (either on the portable device or docking station) such that PCI devices in the docking station may be controlled by the portable device.

These PCI bridge based docking systems, while addressing the problems inherent in early docking systems, add significant cost to the system during manufacture as the chips themselves are relatively expensive, and provide unnecessary and unused functionality for hot docking & undocking operations. Additionally, due to the complexity of PCI Bridge chips (PCI chips are generally highly refined ASIC chips which require significant software drivers to control functionality) and associated software controls, they take a great deal of time in connecting the portable device and docking station during docking and undocking operations. In the increasingly price driven market for portable computers, solutions for reducing cost in the components and manufacturing processes of these devices are highly sought after. Additionally, a simplified hot docking solution which allows users to connect and disconnect portable computing devices from a docking station quickly, such that minimal time is spent waiting for hardware handshaking to occur, would be highly beneficial. Therefore, it would be desirable to create a new low cost simplified hot docking system which is able to connect and disconnect a running portable device to a docking station more quickly than current PCI bridge based systems.

### SUMMARY OF THE INVENTION

In one aspect of the present invention, a system and device for accomplishing hot docking or hot swapping functions between a computer and docking station or peripheral device is disclosed. In general the system of the present invention makes use of the PCI architecture and specifications (which is commercially available from the PCI Special Interest Group or PCISIG) to accomplish docking and swapping functions between the PCI bus of a computing device and a docking station or PCI peripheral device, however it will be understood and appreciated by those skilled in the art that the logic circuits and overall process flow for docking and undocking procedures of the present invention are broadly applicable to docking and swapping functions in all computing devices.

The hot docking and undocking system of the current invention may be configured using a combination of simple CMOS logic gate circuits which employ PCI bus protocol functions. There are three main objectives of the current invention, namely to configure the system such that the PCI devices of the docking station may be connected to a running portable computing device, to configure the PCI bus system of the portable device to use PCI device on the docking station, and to successfully control the PCI devices in the docking station from the PCI bus of the portable computer.

In one aspect of the present invention, new system signals are generated for interacting with the PCI system during hot docking and undocking operations.

In another aspect of the present invention, CMOS logic gate circuits embodying both the new signals and traditional PCI system signals are configured on a docking station to accomplish traditional docking and undocking functionality such as electrical isolation and hardware handshaking in the hot dock system.

In yet another aspect of the current invention, one or more of the new circuit elements are placed in the portable computing device to expedite the docking and undocking processes.

In a further aspect of the present invention, timing sequences governing the new hot docking and undocking procedures are provided.

This invention has been described herein in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense.

### BRIEF DESCRIPTION OF THE DRAWINGS

For a fuller understanding of the nature and advantages of the present invention, as well as the preferred mode of use, reference should be made to the following detailed description read in conjunction with the accompanying drawings. In the following drawings, like reference numerals designate like or similar parts throughout the drawings.

FIG. 1 is a schematic view of the hot docking system of the current invention.

FIG. 2 is a schematic representation of the process flow governing both hot docking and hot undocking procedures.

FIG. 3 is a schematic representation of the hot dock timing sequence of the current invention.

FIG. 4 is a schematic representation of the hot undock timing sequence of the current invention.

FIG. 5 is a schematic representation of the PCI_SW_EN# circuit of the current invention.

FIG. 6 is a schematic representation of the REQ# circuit of the current invention.

FIG. 7 is a table showing the timing sequence of the REQ# circuit.

FIG. 8 is a schematic representation of the BUS_IDLE circuit of the current invention.

FIG. 9 is a schematic representation of the SYSTEM_REQ# of the current invention.

### DETAILED DESCRIPTION OF THE PREFERRED EMBODIMENT

The present description is of the best presently contemplated mode of carrying out the invention. This description is made for the purpose of illustrating the general principles of the invention and should not be taken in a limiting sense. The scope of the invention is best determined by reference to the appended claims.

All publications referenced herein are fully incorporated by reference as if fully set forth herein.

The present invention can find utility in a variety of implementations without departing from the scope and spirit of the invention, as will be apparent from an understanding of the principles that underlie the invention. Reference is made throughout this description of the invention to a hot docking system and device for use in docking stations and portable computers, however it is understood that the hot docking system of the current invention may be applied for portable devices of any kind which require docking functionality to external PCI devices. It is also understood that while the present invention is best explained in reference to portable computer devices, it will nonetheless have broad application in all areas of hot docking, hot swapping, or hot plug systems.

It should be understood and appreciated by those skilled in the art that most signals (including FRAME#, IRDY#, GNT#, REQ#, and CLK#) as used in describing the signals of the current invention are standard PCI signals according to the PCI 2.2 specification.

System Overview/Design Considerations

One goal of this present invention is to provide a low cost hot docking system that is able to quickly connect the PCI bus of a portable computer to the PCI devices in a docking station. The hot docking system of the current invention provides a low cost system for use in docking stations and portable computers which enables quick and reliable connection of the portable computers PCI bus to PCI devices in the docking station by using relatively simple and inexpensive CMOS logic gate circuits and new docking and undocking timing sequences. In so doing, expensive PCI Bridge chips are not required to enable hot docking functions of the system.

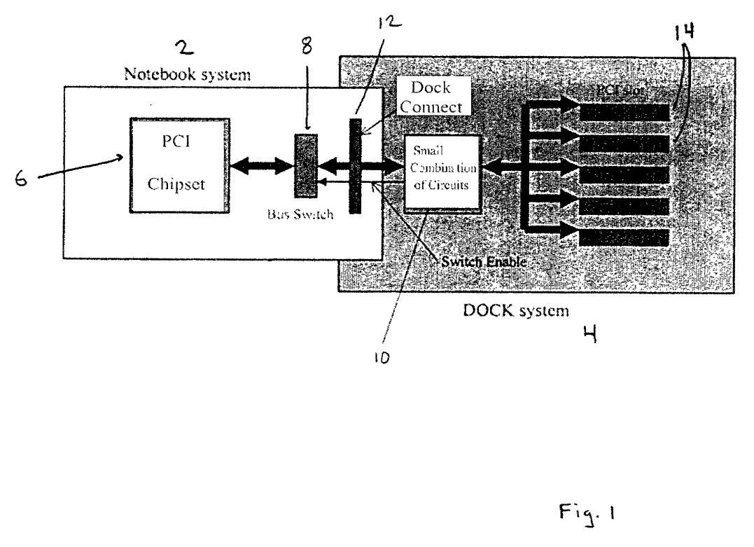

FIG. 1 illustrates the architecture of the current system, wherein a collection of logic circuits 10 of the current invention are placed on the docking station 4 to accomplish the docking and undocking functions traditionally performed by PCI bridge chips. Portable computer 2 is shown physically docked with docking station 4 via dock connect 12. A main object of the current invention is to control PCI devices in the PCI slots 14 using the PCI chipset 6 on the portable computer 2. The circuits 10 in conjunction with bus 8 allow for electrical isolation of portable computer and dock during docking and undocking, as well as providing hardware handshaking functions to enable operation of the PCI devices on the dock.

In general, the system comprises circuits for detecting the state of the PCI Bus on the portable computer, generating a trigger signal for enabling hot dock or undock operations, generating a bus request signal for initiating communication requests with the system bus arbiter, generating a bus grant signal for indicating bus availability to PCI devices, generating a switch enable signal to open the PCI bus on both portable computer and docking station for connection, and a clock buffer for generating a PCI clock signal for all PCI devices.

The primary bus hot docking system of the present invention is based on three fundamental concepts. The first concept concerns the PCI bus idle state which may be monitored through the FRAME#, IRDY# and GNT# signals. When FRAME# and IRDY# signals are low, no PCI device is accessing the PCI bus, indicating that the bus is in an idle state. Additionally, it is known that when GNT# is low, the bus is ready to connect to a specified PCI device. A new signal “BUS_IDLE” can thus be created which indicates the true bus idle state as represented by the following relationship:

BUS_IDLE=FRAME#*IRDY#* !GNT#

[where “*” is AND, “!” is NOT, “#” means active low]

The second concept involves defining PCI_EN_REQ as a new trigger signal generated by a standard micro controller of the docking system. By setting the bus request signal REQ# low, the arbiter will make the bus grant signal GNT# low when ready, indicating to the dock PCI bus that docking or undocking may be initiated with the PCI_EN_REQ signal. The third concept involves opening the connection between the PCI bus on the portable computer and PCI device on the docking station. A new signal is defined as PCI_SW_EN# which corresponds to opening the PCI bus switch to enable operation of the selected PCI device on the docking station. Fundamentally, because PCI_SW_EN# is active low and functions to open the PCI bus on the portable computer, PCI_SW_EN# should be low when the PCI bus of the portable system is to connect with the PCI bus of the dock. Conversely, when undocking is in progress, PCI_SW_EN# should be high to disconnect the PCI bus of the portable computer from the PCI bus of the dock. The relationship governing this signal is defined as follows:

PCI_SW_EN# (in current state)=!PCI_IDLE*PCI_SW_EN# (in last state)+PCI_IDLE*!PCI_EN_REQ

[where “+” is OR]

The new system signals (BUS_IDLE, PCI_EN_REQ, and PCI_SW_EN#) as described and defined above, in conjunction with hardware elements of the system as defined below, enable the hot docking and undocking functionality of the present invention.

Hardware

It should be initially noted that the present invention is not directed toward a mechanism for triggering or anticipating physical connection and disconnection between the portable computer and dock such as leading pin or proximity detection mechanisms. However, such mechanisms may be used in conjunction with the present invention to enhance the robustness of the system, however, any known triggering mechanism which causes the system BIOS of the portable computer to generate docking or undocking commands may be used to initiate docking and undocking processes in the docking station according to the present invention.

According to the preferred embodiment, hardware components of the current invention are placed on the dock system 4 so that while the portable computer 2 is running, the dock (via the system of the current invention) can sense the docking state of the portable computer. It may be desirable to include one or more elements of the system on the portable computer, such as the GNT# signal element which interacts only with the PCI bus of the portable computer.

Four main circuit elements as shown in FIGS. 5,6, 8, and 9 are used to generate system signals of the present invention. According to the preferred embodiment of the present invention, system logic circuits are fabricated in CMOS devices. CMOS circuit devices have an advantage of using very little power to accomplish electrical operations, however it will be understood by those skilled in the art that many different logic circuit fabrication materials and techniques (such as diodes or resistor/transistor logic) may be used to construct logic circuits described herein without departing from the spirit and scope of the current invention. In general the logic circuits of the present invention comprise simple configurations of logic gates to accomplish various functions.

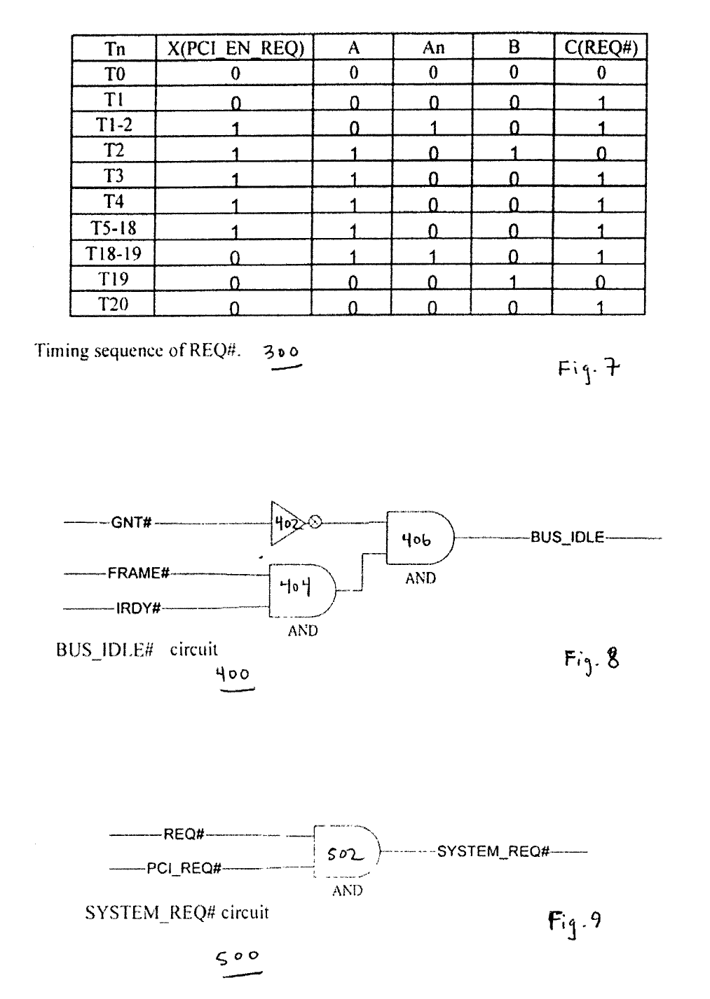

Looking first to FIG. 8, the BUS_IDLE signal is shown being generated from a combination of the FRAME#, IRDY# and GNT# signals. FRAME# and IRDY# are combined in a first AND gate 404, while GNT# is passed through NOT gate 402. As described above, it is important that GNT# not be low at this time as the PCI bus would not be idle with GNT# low. The output signals of (FRAME# AND IRDY#) are then combined in second AND gate 406 with the !GNT# signal (where ! means NOT) from NOT gate 402. The resulting signal BUS_IDLE is the output signal of the BUS_IDLE# circuit and may be routed to both REQ# and PCI_SW_EN# circuits.

Looking now to FIG. 5, the circuit model for generating the PCI_SW_EN# is shown. Here the PCI_EN_REQ signal from the dock micro controller, the BUS_IDLE signal, and CLK signals are used in generating PCI_SW_EN# signal. The PCI_EN_REQ signal (from dock microprocessor) is routed to both NOT 102 and AND 104 gates. The BUS_IDLE signal (from BUS_IDLE circuit as shown in FIG. 8) goes through NOT gate 106, the output signal of which is routed to AND gate 104. As such AND gate 104 produces the combined signal from PCI_EN_REQ and the !BUS_IDLE signal which is routed to OR gate 110. The output signal !PCI_EN_REQ from NOT gate 102 is routed to AND gate 108, and the combination of output Q from D CMOS Flip-Flop 112 (“D Flip-Flop,” as it is commonly known in the industry) and !PCI_EN_REQ is routed to OR gate 110. Both the CLK signal and output signal from OR gate 110 are routed to D Flip-Flop 112 which produces the PCI_SW_EN# signal according to the current invention.

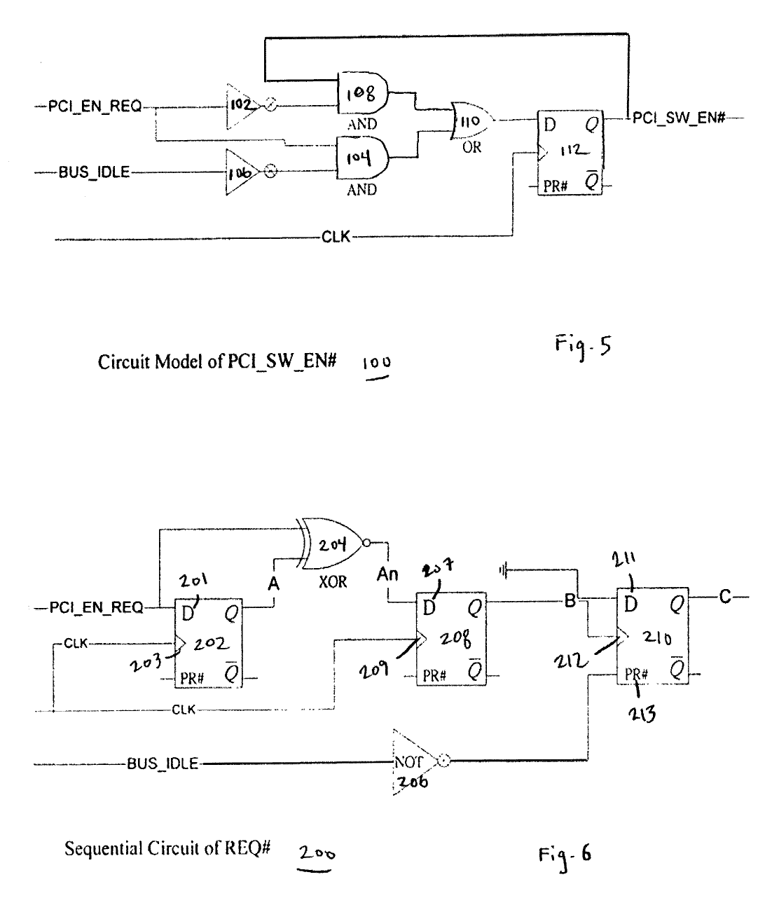

Looking now to FIG. 6, the sequential REQ# circuit is shown. According to the present invention, PCI_EN_REQ, CLK, and BUS_IDLE signals are routed through a series of synchronous D Flip-flops in order to produce REQ# signal C. Initially, CLK and PCI_EN_REQ signals are presented as input for D Flip-flop 202, CLK being routed to CLK input 203 and PCI_EN_REQ to input D 201. CLK is also routed to CLK input 209 of D Flip-flop 208. In addition, PCI_EN REQ is also routed to exclusive OR gate (XOR) 204 along with output A from D Flip-flop 202. The signal An from XOR gate 204 is routed to D Flip-flop 208 along with the CLK signal. Signal B, the output from D Flip-flop 208 is used as the CLK input 212 for D Flip-flop 210. Input D 211 is grounded. The BUS_IDLE signal is routed through NOT gate 206 to generate the !BUS_IDLE. !BUS_IDLE is routed to the preset input PR# 213 of D Flip-flop 210 to preset REQ# signal C to high. The REQ# signal C is output from D Flip-flop 210.

In order to illustrate the operation of the REQ# circuit during docking and undock, a timing sequence table 300 is shown in FIG. 7. In the initial clock state TO, all input and outputs are low. After dock power on T1, BUS_IDLE will preset the REQ# signal C to high so that it is not active. When the PCI bus on the portable computer is idle and PCI_EN_REQ is high, the REQ# circuit sets output C low (T1-T2). The !BUS_IDLE then presets REQ# C high to disable any bus request signal (T3). The PCI_SW_EN# circuit at this time sets PCI_SW_EN#t active to enable connection of the PCI bus to the portable computer.

Looking to FIG. 9, the SYSTEM_REQ# circuit of the current invention is shown. The REQ# and PCI_REQ# signals are combined in AND gate 502 to produce the SYSTEM_REQ# signal. PCI REQ# is the combination of all PCI bus requests and REQ# is the bus request signal of the current invention. It is important to combine these signals so that the true state of system bus requests may be discerned.

Because no PCI bridge is employed in the current invention to generate a clock signal, a clock buffer (can be from the main PCI clock) which is able to tune the clock skew from input to output is necessary to adjust system timing appropriately. Additionally, to further finely adjust system timing for smooth and error free operation, appropriate trace lengths should be designed on the printed wiring boards embodying components of the docking station, including the circuits of the current invention. Both adjustments to clock skew tunability and routing trace lengths are subjects of design consideration which are well known and commonly practiced in the field of circuit design. Those skilled in the art will appreciate the nature of such considerations and be able to design elements appropriately in light of product requirements, manufacturing tolerances, and cost concerns.

Software/Controls

It will be understood and appreciated by those skilled in the art that appropriate software controls for process flow, timing specification and circuitry for accomplishing hot docking and undocking functions of the present system may be programmed using a variety of different methods and a variety of different platforms without departing from the sprit and scope of the present invention. Given the included figures and descriptions above, it will be a routine matter for those skilled in the art of software engineering to develop a software component which interacts appropriately with circuitry of the system and adheres to the process flow and timing specifications of the current invention.

System Process Flow and Timing

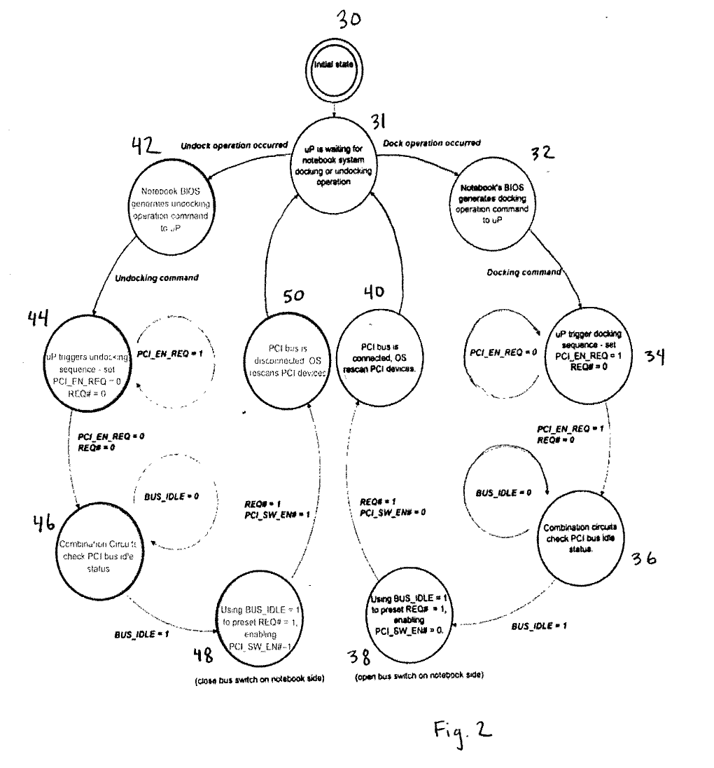

It will be helpful in explaining the operation of circuits in the present invention to examine the process flow governing both docking and undocking operations. Looking now to FIG. 2, initial state 30 is shown as a system state during normal operation of the portable device. In this state no docking or undocking operations are in progress. In state 31, the microprocessor of the docking station is waiting for docking or undocking operations to occur. Once a docking operation begins (ie. The portable computer is placed in the docking station) the BIOS of the portable computer generates a docking operation command 32 to the microprocessor of the docking station. Once received, the dock microprocessor triggers the docking sequence 34 by setting PCI_EN_REQ=1 and REQ#=0. The system cycles an additional clock cycle if PCI_EN_REQ=0 until PCI_EN_REQ=1. The logic circuits of the current invention then check the PCI bus idle status 36 until BUS_IDLE=1. If BUS_IDLE=0 the system must cycle another time. Once the bus is idle, the bus switch on the portable computer is opened 38 by using BUS_IDLE=1 signal to preset the REQ#=1 which enables PCI_SW_EN#=0. When both REQ#=1 and PCI_SW_EN#=0 the PCI bus is connected and the operating system on the portable computer may rescan the PCI devices 40. At this time PCI devices on the dock may be controlled by the PCI bus of the portable computer, and at state 31, the dock microprocessor returns to waiting for undocking operation from the portable computer. When an undock operation occurs (ie. the portable computer begins to be removed from the dock) the portable computers BIOS will generate an undocking command 42 to the microprocessor of the dock. Upon receiving the undocking command, the dock microprocessor triggers the undocking sequence 44 by setting PCI_EN_REQ=0 and REQ#=0. The system cycles if PCI_EN_REQ=1 until PCI_EN_REQ=0 is set. The bus idle status is then checked 46 by system logic circuits until BUS_IDLE=1. If BUS_IDLE=0 the system must cycle until BUS_IDLE=1. The bus switch on the portable computer is then closed 48 using BUS_IDLE=1 to preset REQ#=1 which enables PCI_SW_EN#=1. When both REQ#=1 and PCI_SW_EN#=1 the PCI bus on the portable device is disconnected and the operating system rescans the PCI devices 50. At state 31 once again the dock microprocessor is waiting for docking operation from the portable computer.

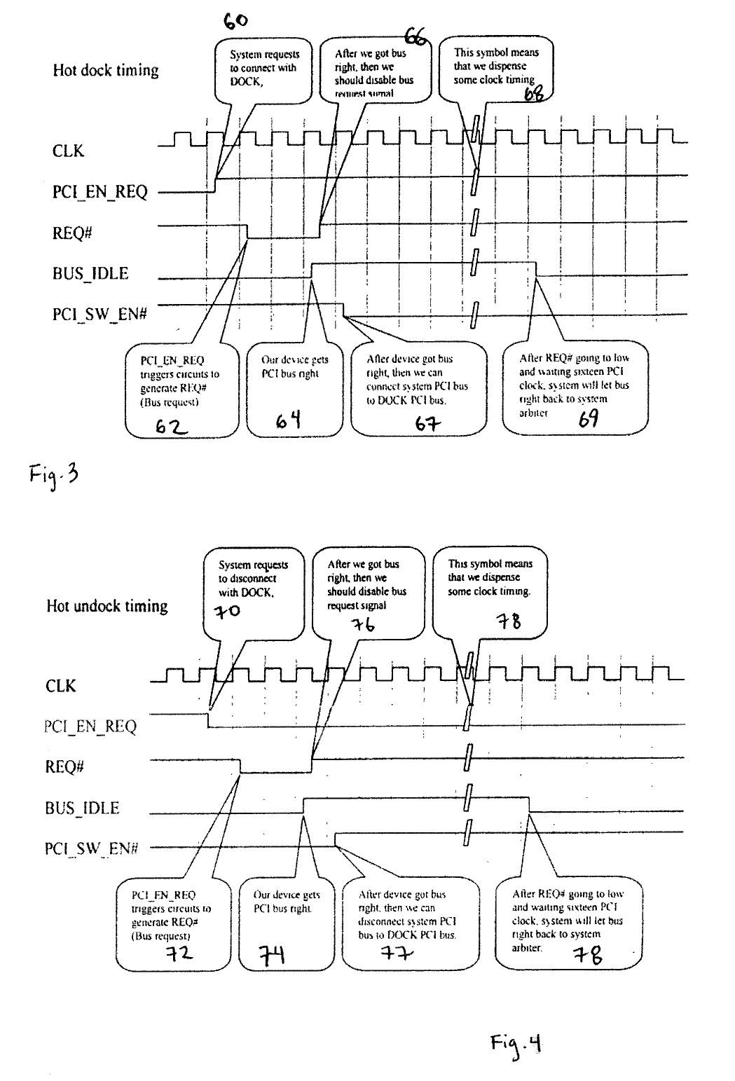

Looking now to FIGS. 3 and 4, the timing of the system (corresponding to the process flow shown in FIG. 2) in relation to the system clock for both docking and undocking is shown. FIG. 3 illustrates the timing specification for docking operations. At time 60, PCI_EN_REQ is triggered high indicating a system request to connect with the dock. The REQ# is triggered low at time 62 to trigger system circuits to generate a bus request according to the PCI specification. When the bus is detected as idle by the system circuits, BUS_IDLE is set high at time 64 indicating that the bus switch may be opened. Before the bus is opened however, the bus request signal is disabled by setting REQ# high once again at time 66. This prohibits the PCI bus on the portable device from granting bus requests during the dock operation. PCI_SW_EN# is triggered low at time 67 and the PCI bus of the portable computer is opened to connect to the PCI bus of the dock. Time 68 indicates the passage of clock cycles (approximately 16 cycles in the preferred embodiment), after which BUS_IDLE# is triggered low granting ownership of the PCI bus to the system arbiter.

FIG. 4 illustrates the timing specification for undocking operations. At time 70, PCI_EN_REQ is triggered low indicating a system request to disconnect with the dock. The REQ# is also triggered low at time 72 to trigger system circuits to generate a bus request according to the PCI specification. Once again, when the bus is detected as idle by the system circuits, BUS_IDLE is set high at time 74 indicating that the bus switch may be closed. Before the bus is closed however, the bus request signal is once again disabled by setting REQ# high at time 76. This prohibits the PCI bus on the portable device from granting bus requests during the undock operation. PCI_SW_EN# is triggered high at time 77 and the PCI bus of the portable computer is closed to disconnect the PCI bus of the dock. Time 78 indicated the passage of clock cycles (approximately 16 cycles in the preferred embodiment), after which BUS_IDLE# is again triggered low indicating ownership of the PCI bus to the system arbiter.

It should be understood and appreciated by those skilled in the art that the system timing sequences discussed above are example timing specifications used to generate circuits for the hot dock system. In practice, for example, signal triggers and clock timing may vary from the above specification due to inherent system limitations and imperfections. This fact in no way should detract from the spirit and scope of the current invention as it relates to a simplified architecture and process flow for a hot docking and undocking system using logic circuits.

The system of the present invention has been described above in terms of schematic diagrams and functional modules in block diagram format. It is understood that unless otherwise stated to the contrary herein, one or more functions may be integrated in a single physical device with associated software control, or one or more functions may be implemented in separate physical devices with software control without departing from the scope and spirit of the present invention.

It is appreciated that detailed discussion of the actual implementation of each module is not necessary for an enabling understanding of the invention. The actual implementation is well within the routine skill of a programmer and system engineer with basic understanding of PCI architecture and specifications, given the disclosure herein of the system attributes, functionality and inter-relationship of the various functional modules in the system. A person skilled in the art, applying ordinary skill can practice the present invention without undue experimentation.

While the invention has been described with respect to the described embodiments in accordance therewith, it will be apparent to those skilled in the art that various modifications and improvements may be made without departing from the scope and spirit of the invention. Accordingly, it is to be understood that the invention is not to be limited by the specific illustrated embodiments, but only by the scope of the appended claims.

1. A system for hot-coupling and hot-decoupling of a PCI device in a first device and a PCI bus in a second device without powering down system power in the second device, wherein at least one of the first and second devices includes a PCI bridge, said system comprising:
a logic circuit provided in at least one of the first and second devices, said logic circuit generating a first signal for controlling hot-coupling of the PCI device and the second signal for controlling hot-decoupling of the PCI device and the PCI bus independent of control of the PCI bridge; and
control means for controlling coupling and decoupling of the PCI device and the PCI bus based on the first and second signals independent of the PCI bridge.

2. A system as in claim 1, wherein the first device is a docking station that comprises the PCI device, and the second device is a portable computing device.

3. A system as in claim 2, wherein the portable computing device is a notebook computer.

4. A system as in claim 1, wherein the logic circuit is embodied independent of integrated circuits.

5. A system as in claim 4, wherein the logic circuit comprises a CMOS circuit element.

6. A system as in claim 1, wherein the logic circuit comprises:
an idle detection circuit for detecting the idle state of the PCI bus;
a system request circuit operatively connected to the idle detection for selectively enabling and disabling the PCI bus;
a PCI enable circuit operatively connected to said idle detection circuit and said system request circuit for selectively opening the PCI bus for enabling communication with the PCI device and closing the PCI bus to disable communication with the PCI device.

7. A system as in claim 6, wherein the idle detection circuit includes input PCI signals GNT#, FRAME#, and IRDY# such that an output signal BUS_IDLE is equal to the sum of FRAME#, IRDY#, and !GNT#.

8. A system as in claim 6, wherein the system request circuit includes input PCI signals REQ# and PCI_REQ# such that an output signal SYSTEM_REQ# is equal to the sum of REQ# and PCI_REQ#.

9. A system as in claim 6, wherein the PCI enable circuit includes:
a first circuit state and a second circuit state;
input PCI signals PCI_EN_REQ, CLK, and the signal BUS_IDLE;
wherein a first output signal corresponding to the second circuit state is equal to the sum of !PCI_IDLE and the first circuit state, and a second output signal corresponding to the first circuit state is equal to the sum of PCI_IDLE and !PCT_EN_REQ.

10. A method for hot-coupling and hot-decoupling of a PCI device in a first device and a PCI bus in a second device without powering down system power in the second device, wherein at least one of the first and second devices includes a PCI bridge, said method comprising:
providing a logic circuit in at least one of the first and second devices, said logic circuit configured to generate a first signal for controlling hot-coupling of the PCI device and the PCI bus independent of control of the PCI bridge, and to generate a second signal for controlling hot-decoupling of the PCI device and the PCI bus independent of control of the PCI bridge; and
controlling the coupling and decoupling of the first and second devices based on the first and second signals independent of the PCI bridge.

11. A docking device for hot docking and undocking a portable device that includes a PCI bus and a PCI bridge without powering down system power in said portable device, said docking device comprising:
a logic circuit generating a first signal for controlling hot-docking of the portable device in which the PCI device is coupled to the PCI bus independent of control of the PCI bridge, and generating a second signal for controlling hot-undocking of the portable device in which the PCI device is decoupled from the PCI bus independent of control of the PCI bridge; and
control means for controlling the coupling and decoupling of the PCI device and the PCI bus based on the first and second signals independent of the PCI bridge.

12. A system for hot docking and undocking of a portable device having a PCI bus, from a docking station having a PCI device, comprising:
a plurality of logic circuits comprising;
means for monitoring the PCI bus idle state;
means for triggering hot docking and undocking operations;
means for opening and closing the PCI bus switch for selectively hot docking and undocking the PCI device and the PCI bus.
control means for controlling docking and undocking of the PCI device and the PCI bus by using said means for monitoring to initiate said means for triggering, and using said means for triggering to initiate said means for opening and closing the PCI bus switch.

13. A method of hot docking a portable device having a PCI bus and a docking station having a PCI device, comprising the steps of:
providing a plurality of logic circuits operatively connected to said PCI bus and to said PCI device;
detecting a docking operation;
generating a docking operation command in the portable device and sending said command to a microprocessor of the docking station;
triggering a docking sequence in the logic circuits;
checking the PCI bus idle status using the logic circuits;
opening the PCI bus switch;
Rescanning the PCI bus to detect and connect the PCI device.

14. A method of hot undocking a portable device having a PCI bus and a docking station having a PCI device, comprising the steps of:
providing a plurality of logic circuits operatively connected to said PCI bus and to said PCI device;
detecting an undocking operation;
generating an undocking operation command in the portable device and sending said command to a microprocessor of the docking station;
triggering an undocking sequence in the logic circuits;
checking the PCI bus idle status using the logic circuits;
closing the PCI bus switch;
rescanning the PCI bus to disconnect the PCI device.
